(19) United States
(12) Patent Application Publication
(10) Pub. No.: US 2024/0282020 A1
(43) Pub. Date: Aug. 22, 2024

(54) Light Compensations for Virtual Backgrounds

(71) Applicant: Hewlett-Packard Development Company, L.P., Spring, TX (US)

(72) Inventors: Alexander Williams, Spring, TX (US); Gregory Staten, Spring, TX (US); Anthony Kaplanis, Spring, TX (US)

(21) Appl. No.: 18/571,499

(22) PCT Filed: Jun. 23, 2021
(86) PCT No.: PCT/US2021/038578

§ 371 Date: Dec. 18, 2023

(51) Int. Cl. G06T 11/00; G06T 7/90; G06V 20/40

(52) U.S. Cl. CPC G06T 11/001; G06T 7/90; G06V 20/41; G06T 2207/10016; G06T 2207/10024; G06T 2207/20021; G06T 2207/20072

(57) ABSTRACT

In example implementations, an apparatus is provided. The apparatus includes a video camera to capture an image of a participant on a video call, an ambient light sensor to detect light, and a processor communicatively coupled to the video camera, the memory, and the ambient light sensor. The processor is to identify a portion of a video image of the video call that includes the image of the participant, detect a type of light on the participant based on the light detected by the ambient light sensor, and perform a light compensation to match a color range of the image of the participant and a color range of a background image selected for the video call based on the type of light that is detected.

### BACKGROUND

As more workers work from home, video conferencing has become a popular choice for communicating or holding meetings. Video conferencing or virtual meetings allow users to communicate with one another with video and audio and allow users to share screens and/or data on a screen. Thus, video conferencing can be very productive.

However, with video conferencing, the video camera may capture the background of a user as well. The user may not want to share personal items up on walls, or details of his or her home, via the video shared on the video conference. As a result, some users may use virtual backgrounds to hide the real backgrounds of the users' homes.

### BRIEF DESCRIPTION OF THE DRAWINGS

FIG. 1 is a block diagram of an example light compensation apparatus of the present disclosure;

FIG. 2 is a block diagram of an example environment with various light sources and another example light compensation apparatus with a controllable light source of the present disclosure;

FIG. 3 is an example of how lighting in a virtual background image is adjusted to match the lighting in a foreground image of the present disclosure;

FIG. 4 is a flow chart of an example method to perform light compensations for virtual backgrounds of the present disclosure; and

FIG. 5 is an example non-transitory computer readable storage medium storing instructions executed by a processor to perform light compensations for virtual backgrounds of the present disclosure.

### DETAILED DESCRIPTION

Examples described herein provide an apparatus, and a method for using the same, to perform light compensations for virtual backgrounds. As discussed above, more users are using video conferencing or virtual meetings as more people work from home. Many participants on a video call may deploy a virtual background to prevent other participants on the video call from seeing their personal belongings or details within a room. In other instances, the participant may not want other participants to know where they are located. As a result, a participant may want to deploy a virtual background to mask their whereabouts.

Whatever the reason may be, the virtual background may appear artificial or be distracting if the lighting of the virtual background is different from the lighting on the participant in the video call. The difference may be further exaggerated depending on a quality of a video camera the participant is using. Thus, in some cases, the virtual background may look noticeably unnatural compared to the video image of the participant.

The present disclosure provides an apparatus and method to perform light compensations on the virtual background image or the foreground image/image of the participant based on the lighting on the participant of the video call. The foreground image or pixels associated with the participant may be determined, and the type of light on the foreground image may be detected. Based on the lighting effects for the virtual background image, the foreground image and/or both the virtual background image and the foreground image can be compensated based on the light effects that are detected. Thus, the lighting on both the virtual background image and the foreground image may be adjusted to match one another and to make the virtual background image appear to be more natural.

In some examples, the different type of lighting on the participant may be detected and used to adjust different regions of the virtual background image or the foreground image based on the different type of lighting in the different regions. In other examples, the apparatus may have a controllable light that can be adjusted based on the desired light compensations to the virtual background or the foreground image. Thus, the present disclosure may perform light compensations on the virtual background image or the foreground image based on a type of light source that is detected on a participant to allow the virtual background image to appear more natural with the video image of the participant.

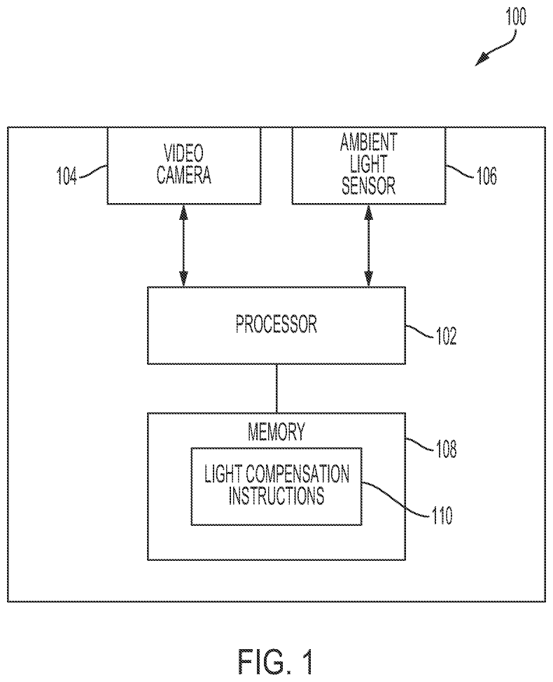

FIG. 1 illustrates an example light compensation apparatus 100 of the present disclosure. In an example, the apparatus 100 may include a processor 102, a video camera 104, and an ambient light sensor 106. It should be noted that the apparatus 100 has been simplified for ease of explanation and may include additional components that are not shown. For example, the apparatus 100 may include a display, input/output devices (e.g., a mouse, a trackpad, a keyboard, and the like), a microphone, interfaces to connect external devices (e.g., universal serial bus (USB) interfaces), and the like.

In an example, the processor 102 may be communicatively coupled to the video camera 104 and the ambient light sensor 106 to control operation of the video camera 104 and the ambient light sensor 106. The processor 102 may also receive data from the video camera 104 and the ambient light sensor 106 (e.g., video images captured by the video camera 104 and light information collected by the ambient light sensor 106).

The processor 102 may execute various applications that are stored in a memory 108. The memory 108 may be any type of non-transitory computer readable storage medium. For example, the memory 108 may be a hard disk drive, a solid state drive, a random access memory (RAM), a read-only memory (ROM), and the like. For example, the processor may execute a video call application that allows a participant or user of the apparatus 100 to communicate with other participants on the video call.

As noted above, in some instances during a video call, a background of the video call (e.g., a virtual background) can appear to have a different color or color tones than a foreground image or image of the participant. This may be due to different lighting that is directed at the participant. In one example, the processor 102 may execute light compensation instructions 110 stored in the memory 108 to perform light compensations for backgrounds of the video images produced during the video call. The light compensation may be performed based on light information collected by the ambient light sensor 106.

In an example, the video camera 104 may be any type of image capturing device that can collect video images of a participant. For example, the video camera 104 may be a red, green, blue (RGB) camera. The video camera 104 may capture a video image of the participant that includes a plurality of video frames, where each video frame is comprised of a plurality of pixels. The processor 102 may analyze the color value of each pixel of each video frame to perform the light compensation of the video images, as discussed in further details below.

In an example, the ambient light sensor 106 may be any photodetector that can measure an amount of light (e.g., an amount of illuminance measured in lux). The ambient light sensor 106 may be a phototransistor, a photodiode, a photonic integrated circuit, and the like. Although a single ambient light sensor 106 is illustrated in FIG. 1, it should be noted that any number of ambient light sensors 106 may be deployed. Multiple ambient light sensors 106 may improve the accuracy of determining a direction of a particular light source.

In an example, the processor 102 may analyze the light information collected by the ambient light sensor 106 to determine a type of light source and a direction of the light source. For example, the memory 108 may store a table of types of standard illuminants.

These standard illuminants can be cross-referenced with pre-calculated corrections to neutralize the tonal shift caused by the ambient illumination or a poor auto white balance by the camera. For example, different types of color compensation may be applied to images with a more yellowish light temperature than may be applied to images with a bluish white light temperature. Examples of different color compensations may include pre-calculated look up tables (LUTs), designated hue and saturation corrections, red, green, and blue (RGB) channel gain and lift adjustments, and the like.

Based on the color temperature of different portions of the image of the participant, the processor 102 may determine a type of light source and a direction from which the light is coming from the light source. For example, if the top portion of the video image has a color temperature of 2900 Kelvin, the processor 102 may determine that an indoor yellow light bulb is being used overhead. If the right side of the image has a color temperature of 6600 Kelvin, the processor 102 may determine that daylight is entering the video image from the right side, and so forth.

Using the determined type of light source and the direction the light is coming from, the processor 102 may execute the light compensation instructions 110. For example, the light compensation instructions 110 may cause the processor 102 to identify a portion of a video image of the video call that includes the image of the participant. For example, facial recognition technology may be used to detect pixels of the video image that are associated with the participant, machine learning models may be applied that are trained to detect pixels associated with a person in a video image, or any other type of video analysis may be used to detect a participant.

The light compensation instructions 110 may cause the processor 102 to then detect a type of light on the participant based on the light detected by the ambient light sensor 106. For example, the type of light and a direction of the light may be determined, as described above.

The light compensation instructions 110 may cause the processor 102 to then perform a light compensation to match a color range of the image of the participant and a color range of a background image selected for the video call based on the type of light that is detected. The color range may include brightness of the color as well as the color tone and/or shade of the color. For example, the light compensation may be performed based on a comparison of histograms of the color of the foreground image of the participant and the background image. Then, the color range of the foreground image of the participant may be adjusted to match the color range of the background image, or vice versa.

Although color histogram comparisons are provided as an example of a light compensation technique, it should be noted that any light compensation technique can be applied. Other examples of light compensation techniques may include the application of one-dimensional (1D) or three-dimensional (3D) LUTs, color correction matrices, hue/saturation adjustments (e.g., in YC_{R}C_{B} color space), and the like.

Although an example is described above for a background image of a video call, it should be noted that the light compensation of the present disclosure can be applied to any background image and foreground image. For example, video may include a background image from a green screen applied to a foreground image of a user. In another example, a person may be far away from a background structure or image. As a result, the background structure may appear to have a different color range than the user. The light compensation of the present disclosure can be applied to the image to adjust the color range of the background image to match the color range of the person.

In an example, the light compensations may also be performed based on a number of obstructions corresponding to each one of the light sources that is detected. For example, based on shadows that may be detected within a ring of a light source, the processor 102 may determine that there is an obstruction in front of a light source. Thus, the light compensations may be used to add shadows, as well as adjusting a color and/or brightness of the images. For example, the virtual image may be adjusted to show a shadow formed on the participant from an obstruction in front of a light source.

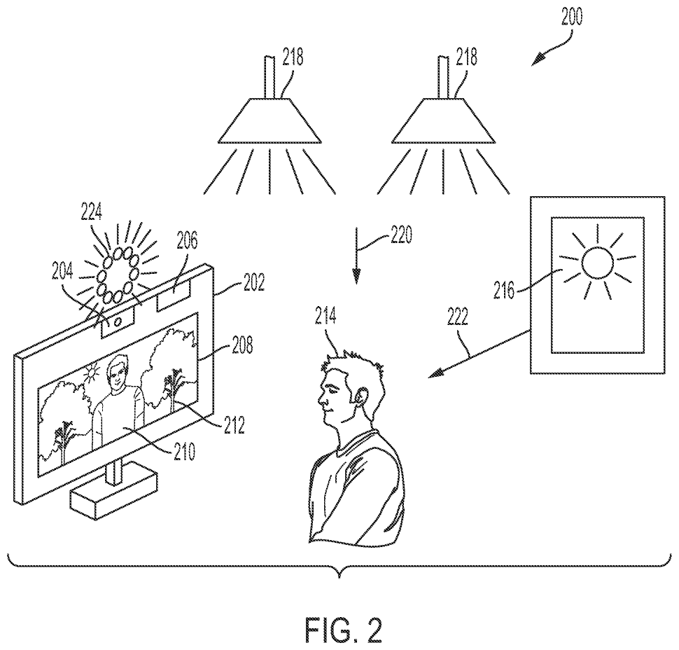

FIG. 2 illustrates a block diagram of an example environment 200 with various light sources and another example of a light compensation apparatus 202 of the present disclosure. In an example, the light compensation apparatus 202 may include a video camera 204 and an ambient light sensor 206. The video camera 204 and the ambient light sensor 206 may be similar to the video camera 104 and the ambient light sensor 106 illustrated in FIG. 1, and described above.

The apparatus 202 may also include a display 208. The display 208 may show video images that are captured by the video camera 204 or updated images that are produced after the light compensation of the present disclosure is applied to the video images captured by the video camera 204. The video image shown by the display 208 may include a foreground image 210 of a participant 214 on a video call and a background image 212.

The background image 212 may be a virtual background image that can be used by the video call application to hide or mask the environment 200 of the participant 214. For example, the environment 200 may be a home office of the participant 214 that includes personal photos and bookshelves behind the participant 214. The virtual background image may be applied by the video call application to hide the personal photos and bookshelves.

In an example, the apparatus 200 may also include a light source 224. The light source 224 may be a ring light that is used for personal videos or images. In an example, the light compensation instructions 110 may include instructions to control a brightness or intensity of the light emitted by the light source 224 in addition to adjusting the color range of the video image.

In an example, the apparatus 202 may include additional components that are not shown. For example, the apparatus 202 may also include a processor (e.g., the processor 102) to control operation of the video camera 204, the ambient light sensor 206, and the light source 224. The apparatus 202 may also include a memory (e.g., the memory 108) and light compensation instructions 110 that are executed by the processor.

The apparatus 202 may be located in the environment 200 that includes additional light sources 218 and 216. For example, the light sources 218 may be overhead LED lights that output a “warm” color temperature of 2700 Kelvin. The light source 218 may direct light at the participant 214 in a direction illustrated by an arrow 220.

The light source 216 may be sunlight that enters the environment 200 through a window. The sunlight may have a color temperature of 7000 Kelvin. The sunlight may be directed at the participant 214 from the right side or horizontally, as shown by an arrow 222.

As discussed above, the ambient light sensor 206 may capture light information associated with light emitted from the light sources 216, 218, and 224. The processor may then analyze the video image to determine a type of light source 216, 218, and 224 and a direction of each light source 216, 218, and 224. The processor may then apply light compensation to the background image 212 to match the color range of the foreground image 210 of the participant 214.

In example, the light compensation may be performed to make the foreground image 210 and the background image 212 have a single color range. For example, the foreground image 210 may be adjusted to match the color range of the portions of the image illuminated by the light source 218. In other words, a light compensation may be applied to the portions of the foreground image 210 illuminated with the light source 216 to match the color range of the portions of the image illuminated by the light source 218. The background image 212 may also be adjusted to match the color range associated with the light source 218.

In another example, the light compensation may be performed to make the foreground image 210 and the background image 212 have the same shadows. For example, the background image 212 may be adjusted to create a shadow that is cast on the participant 214 in the foreground image 210. For example, the shadow may be caused by an obstruction in front of one of the light sources 216, 218, or 224.

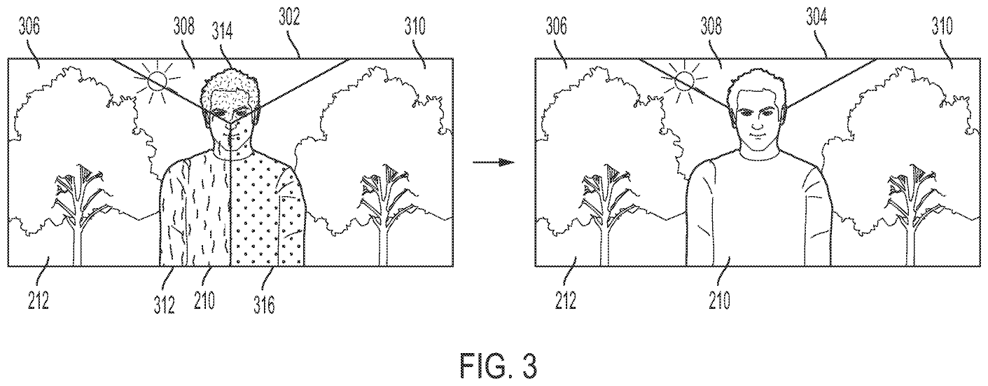

FIG. 3 illustrates an example of how light compensation may be applied to a video image. An initial video frame 302 may include a foreground image of the participant 214 and a background image 212. FIG. 3 illustrates different portions of an initial video frame 302 that have different color ranges illustrated by different shadings.

In an example, the processor of the apparatus 202 may analyze the initial video frame 302 with the light information obtained from the ambient light sensor 206 to divide the initial video frame 302 into different regions. Region 312 may include portions of the video illuminated by the light source 224, region 314 may include portions of the video illuminated by the light source 218, and region 316 may include portions of the video illuminated by the light source 216. Regions 306, 308, and 310 may be part of the background image 212 and may have a color range set by the video call application.

The light compensation may be applied to the initial video frame 302 such that the color range of regions 306, 308, 310, 314, and 316 match the color range of region 312. After the light compensation is applied, an updated video frame 304 may be generated and displayed. As illustrated in FIG. 3, the updated video frame 304 may include the foreground image 210 with a single color range, and the color range of the background image 212 may match the color range of the foreground image 210. In another example, light compensation may be applied to the regions 306, 308, and 310 of the background image 212 and the regions 312, 314, and 316 of the foreground image 210 to match a target color range. The target color range may be a desired color range that is different than the color range of the regions 306, 308, and 310 of the background image 212 and the regions 312, 314, and 316 of the foreground image 210.

In another example, the light compensation may be performed to make corresponding portions of the background image 212 match the color range of different regions of the foreground image 210. As a result, this may allow the background image 212 to appear more natural (e.g., as if the background image 212 is being illuminated by the same light sources in the environment 200 that are illuminating the user 214).

For example, in the updated video frame 304, the foreground image 210 may maintain the color range of different regions 312, 314, and 316. The region 306 may be associated with the region 312, the region 308 may be associated with the region 314, and the region 310 may be associated with the region 316. A first light compensation may be applied to the region 306 to have the color range of the region 306 match the color range of the region 312, a second light compensation may be applied to region 308 to have the color range of the region 308 match the color range of the region 314, and a third light compensation may be applied to the region 310 to have the color range of the region 310 match the color range of the region 316.

In an example, a position of the participant 214 in the video image may be continuously tracked. As the position of the participant 214 changes between video frames, the size and/or portions of the regions 306, 308, and 310 of the background image 212 may change. The light compensation may then be applied to the updated size and/or portions of the regions 306, 308, and 310 accordingly.

For example, if the participant 214 were to shift to the right in the field of view of the video camera 204, the region 306 may grow larger, and the region 310 may shrink to be smaller. If the participant 214 were to stand up in the field of view of the video camera 204, the size of the region 308 would shrink and grow smaller, while the size of the foreground image 210 of the participant 214 may grow larger in the initial video frame 302.

In another example, the light compensation can be performed continuously for a duration of the video call. For example, referring back to FIG. 2, the color temperature of the light source 216 may change over time. For example, the video call may start at 6 PM and end at 7:30 PM near dusk as the sun is beginning to set. As a result, the light compensation applied to the regions 316 and 310 in FIG. 3 associated with the light source 216 may be continuously updated as the color temperature changes over the duration of the video call.

In addition, although examples of the light compensation are described above as a change to the video images, it should be noted that the light compensation may also be performed by changes to hardware. For example, camera settings of the video camera 104 or 204, or changes to display settings of the display 208, may be made to perform the light compensation. The camera settings may include changes to exposure compensation, color range of the video camera 104 or 204, f-stop values, and the like. The display settings may include a brightness of the display 208, color settings for each color of a red, green, blue (RGB) color display, saturation settings, and the like.

In another example, light sources communicatively coupled to the processor of the apparatus 100 or 202 may be adjusted to perform the light compensation. For example, the light source 224 may be controlled to adjust a brightness, an illumination level, a color output of the light source 224, and the like to perform the light compensation. Thus, the light compensation may include changes to the video image and/or changes to controllable light sources (e.g., the light source 224) and/or the video camera 104 or 204.

As a result, the present disclosure may perform light compensation to allow a background image to appear more natural. The background image may not appear as awkward and may allow participants to feel more comfortable using background images in video calls in a professional setting.

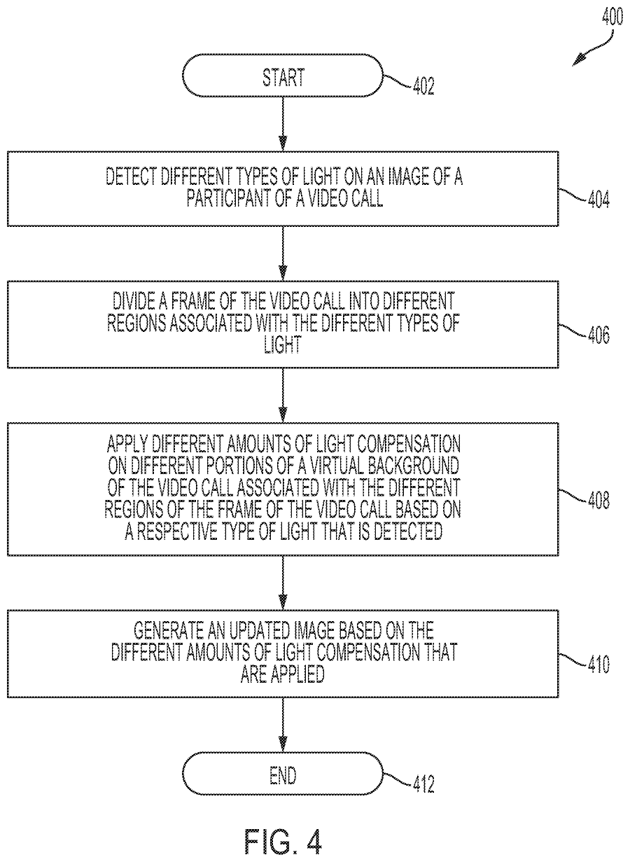

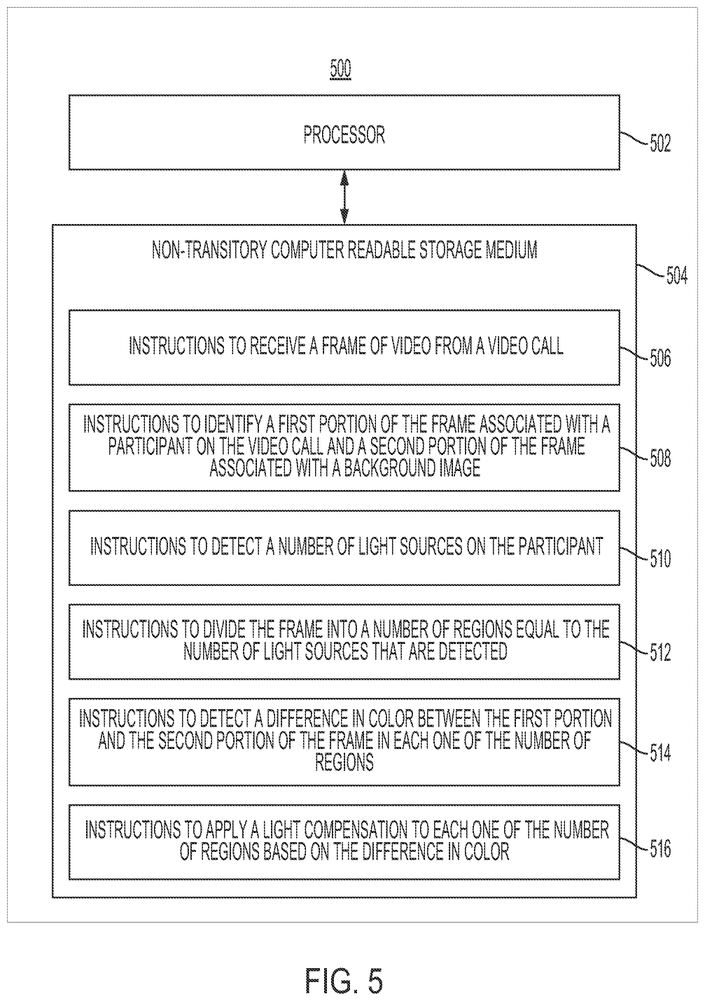

FIG. 4 illustrates a flow diagram of an example method 400 for performing light compensations for virtual backgrounds of the present disclosure. In an example, the method 400 may be performed by one of the apparatus 100 illustrated in FIG. 1 or the apparatus 500 illustrated in FIG. 5 and described below.

At block 402, the method 400 begins. At block 404, the method 400 detects different types of light on an image of a participant of a video call. For example, an ambient light sensor may collect light information in an environment. The light information may be compared to a table that correlates color temperature of the light to a particular type of light source.

At block 406, the method 400 divides a frame of the video call into different regions associated with the different types of light. In an example, the video image may be analyzed to define different regions based on different color temperatures in different portions of the frame of video caused by the different types of light. The different regions may be defined for portions of the frame that include a participant on the video call.

In an example, a direction of each one of the different types of light sources can be detected. The different regions can be divided based on the direction and a type of each one of the different types of light sources. For example, a center of the frame of video may be a region associated with a ring light source on a computer directed at the participant. A top portion of the frame of video may be a region associated with a fluorescent light bulb. A right portion of the frame of video may be a region associated with sunlight that enters the room through a window.

In an example, a position and/or orientation of each one of the different types of light sources can be determined. For example, the positions of each one of the light sources and intensities of each one of the light sources can be calculated based on analysis of the light in each one of the different regions. A correlation between brightness and/or shadowing of the virtual background and the calculated locations of the light sources can be mapped. The map can be used to match the lighting of the foreground image or the image of the participant in the video call.

In an example, the boundaries between the different regions may be defined based on the color value of a pixel being closer to one of the two color temperatures at a boundary. For example, pixels closer to the boundary between two regions may have a color temperature that is in between the color temperature of the two different light sources.

To illustrate, a first region may be associated with a light source with a color temperature of 5000 Kelvin. A second region adjacent to the first region may be associated with a light source with a color temperature of 7000 Kelvin. A pixel near the boundary of the first region and the second region may have a color temperature of 6100 Kelvin. The pixel may be assigned to the second region as the color temperature is closer to 7000 Kelvin than 5000 Kelvin.

At block 408, the method 400 applies different amounts of light compensation on different portions of a virtual background of the video call associated with the different regions of the frame of the video call based on a respective type of light that is detected. For example, the virtual background may be divided into different regions associated with the different regions of the frame of the video call.

For example, the virtual background may be overlaid on the frame of the video call. A portion of the virtual background that overlaps a first region of the frame of the video call may be divided as a first region of the virtual background that is associated with a first region of the frame of the video call, another portion of the virtual background that overlaps a second region of the frame of the video call may be divided as a second region of the virtual background that is associated with a second region of the frame of the video call, and so forth.

Then light compensation that is applied to a particular region of the frame of the video call may also be applied to the associated region of the virtual background. In an example, the light compensation may be applied to the regions such that all regions match a color range of a region of the frame of the video call (e.g., the example illustrated in FIG. 3). In another example, the light compensation may be applied to the regions such that all regions match a target color range.

In another example, different light compensations may be applied to different regions of the virtual background to match the color range of the different regions of the frame of the video call, or the foreground image of the frame that includes the video image of the participant. In an example, different light compensations may be applied to different regions of the foreground image of the frame to match the lighting and/or color of the background. As a result, the virtual background may appear to have the same lighting as the lighting that is being applied to the participant in the video call.

The light compensation may include comparing a histogram of a color range of a first region to a histogram of a color range of a second region. The color range of the second region may be adjusted to match the color range of the first region, or vice versa, based on the comparison of the histograms. Other light compensation techniques may include flesh tone analysis and compensation based on the hue/saturation of the speaker's face, application of an illuminant compensation using 1D or 3D LUTs, black point balancing (e.g., to neutralize the blacks in the foreground and background elements), and the like.

At block 410, the method 400 generates an updated image based on the different amounts of light compensation that are applied. The updated image may include the virtual background image and the foreground image of the participant that receive the light compensation, as described above.

In an example, the method 400 may also adjust settings to hardware to perform the light compensation. For example, settings of the video camera and/or light sources may be changed to perform the light compensation.

In an example, the method 400 may be repeated for the duration of the video call. For example, some light sources (e.g., sunlight) may change color temperature over the duration of the video call. Thus, as the color temperature of the light source changes, the method 400 may adjust the light compensation that is performed for the regions affected by the light source that is changing color temperature over time. At block 412, the method 400 ends.

FIG. 5 illustrates an example of an apparatus 500. In an example, the apparatus 500 may be the apparatus 100. In an example, the apparatus 500 may include a processor 502 and a non-transitory computer readable storage medium 504. The non-transitory computer readable storage medium 504 may be encoded with instructions 506, 508, 510, 512, 514, and 516 that, when executed by the processor 502, cause the processor 502 to perform various functions.

In an example, the instructions 506 may include receiving instructions 506. For example, the instructions 506 may receive a frame of video from a video call.

The instructions 508 may include identifying instructions. For example, the instructions 508 may identify a first portion of the frame associated with a participant on the video call and a second portion of the frame associated with a background image.

The instructions 510 may include detecting instructions. For example, the instructions 510 may detect a number of light sources on the participant.

The instructions 512 may include dividing instructions. For example, the instructions 512 may divide the frame into a number of regions equal to the number of light sources that are detected. In another example, the number of regions may be divided based on a number of light source obstructions that are detected. For example, a shadow may be cast based on anything that obstructs the light source (e.g., branches from a tree between the sun and the participant). The virtual background may be compensated for the shadow that is cast on the participant. Thus, a tree branch shadow may cross over the background image as the user walks outside.

The instructions 514 may include detecting instructions. For example, the instructions 514 may detect a difference in color between the first portion and the second portion of the frame in each one of the number of regions.

The instructions 516 may include applying instructions. For example, the instructions 516 may apply a light compensation to each one of the number of regions based on the difference in color. In an example, the instructions 516 may apply the light compensation based on a type of light source that is detected for each one of the number regions. For example, a first type of light compensation may be applied to for incandescent light bulbs and a second type of light compensation may be applied for daylight colored LED light sources.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a video camera to capture an image of a participant on a video call;
an ambient light sensor to detect light; and
a processor communicatively coupled to the video camera and the ambient light sensor, wherein the processor is to:
identify a portion of a video image of the video call that includes the image of the participant;
detect a type of light on the participant based on the light detected by the ambient light sensor; and
perform a light compensation to match a color range of the image of the participant and a color range of a background image selected for the video call based on the type of light that is detected.

2. The apparatus of claim 1, further comprising:
a light source communicatively coupled to the processor.

3. The apparatus of claim 2, wherein the light compensation performed by the processor comprises adjusting a light intensity of the light source.

4. The apparatus of claim 1, wherein the ambient light sensor is to detect a direction of the light and a color of the light.

5. The apparatus of claim 1, wherein the processor to perform the light compensation further comprises a processor to:
compare a color histogram of the image of the participant to a color histogram of the background image that is selected to determine an amount of the light compensation that is to be performed.

6. A method, comprising:
detecting, by a processor, different types of light on an image of a participant of a video call;
dividing, by the processor, a frame of the video call into different regions associated with the different types of light;
applying, by the processor, different amounts of light compensation on different portions of a virtual background of the video call associated with the different regions of the frame of the video call based on a respective type of light that is detected; and
generating, by the processor, an updated image based on the different amounts of light compensation that are applied.

7. The method of claim 6, further comprising:
tracking, by the processor, a location of the image of the participant from a first frame to a second frame of the video call;
changing, by the processor, the different portions of the virtual background associated with the different regions from the first frame to the second frame of the video call as the location of the image of the participant moves; and
applying, by the processor, the light compensation to the different portions of the virtual background associated with the different regions in the second frame of the video call.

8. The method of claim 6, further comprising repeating the detecting, the dividing, and the applying for a duration of the video call.

9. The method of claim 6, further comprising:
detecting, by the processor, a direction of each one of the different types of light sources; and
dividing, by the processor, the frame of the video call into different regions based on the direction and a type of each one of the different types of light sources.

10. The method of claim 6, further comprising:
detecting, by the processor, a position of each one of the different types of light sources; and
dividing, by the processor, the frame of the video call into different regions based on the position and a type of each one of the different types of light sources.

11. A non-transitory computer readable storage medium encoded with instructions which, when executed, cause a processor of an apparatus to:
receive a frame of video from a video call;
identify a first portion of the frame associated with a participant on the video call and a second portion of the frame associated with a background image;
detect a number of light sources on the participant;
divide the frame into a number of regions equal to the number of light sources that are detected;
detect a difference in color between the first portion and the second portion of the frame in each one of the number of regions; and
apply a light compensation to each one of the number of regions based on the difference in color.

12. The non-transitory computer readable storage medium of claim 11, further causing the processor to:
detect a type of light source for each one of the number of light sources that is detected; and
apply the light compensation to each one of the number of regions based on the difference in color and the type of light source.

13. The non-transitory computer readable storage medium of claim 11, wherein the processor to apply the light compensation comprises adjusting a color of the second portion of the video frame within a region to match a color of the first portion of the video frame within the region or adjusting a color of the first portion of the video frame within a region to match a color of the second portion of the video frame within the region.

14. The non-transitory computer readable storage medium of claim 11, wherein the processor to apply the light compensation comprises identifying an obstruction for each one of the number of light sources, determining a shadow created on the first portion of the frame associated with the participant caused by the obstruction, and adjusting a color of the second portion of the video frame to include the shadow.

15. The non-transitory computer readable storage medium of claim 11, wherein the processor to apply the light compensation comprises adjusting a color of the first portion of the video frame and a color of the second portion of the video frame within a region to match a target color range.
